(19) United States
(12) Patent Application Publication
(10) Pub. No.: US 2025/0309618 A1
(43) Pub. Date: Oct. 2, 2025

(54) CONFIGURABLE POWER SOURCE MANAGEMENT DEVICE FOR MULTIPLE ELECTRIC POWER SOURCES

(71) Applicant: Siemens Industry, Inc., Alpharetta, GA (US)

(72) Inventors: Carlos Flores Silguero, Alpharetta, GA (US); Miguel Angel Galeano Martinez, Decatur, GA (US); Cole William Wright, Atlanta, GA (US); Ryan Joseph Reeves, Atlanta, GA (US); Brian Matthew Whalen, Decatur, GA (US)

(73) Assignee: Siemens Industry, Inc., Alpharetta, GA (US)

(21) Appl. No.: 18/617,284

(22) Filed: Mar. 26, 2024

(51) Int. Cl. H02B 1/04; H02B 1/03

(52) U.S. Cl. CPC H02B 1/04; H02B 1/03

(57) ABSTRACT

An electrical distribution panel having a central conductor is provided. The electrical distribution panel includes a plurality of input terminals that are each connected to a source, each of the plurality of input terminals include a circuit protection device, a sensing device, and an isolation device that connect the central conductor to a source, where one or more of the plurality of sources is bidirectional. The electrical distribution panel also includes a plurality of output terminals that are each connected to a load, each of the plurality of output terminals include a circuit protection device, a sensing device, and an isolation device that connect the central conductor to a load and a controller configured to receive data from the sensing device of each of the plurality of input and output terminals and to responsively control the isolation device of each of the plurality of input and output terminals.

### BACKGROUND

Aspects of the present invention generally relate to power management devices and, more specifically, to configurable power source management devices for multiple electric power sources.

Historically, most residential buildings have been powered by a single source of electrical power, namely electricity received from a utility company through a utility owned metering device. The utility metering device may be installed as a separate device or may sit within a meter socket that is located inside an electrical distribution panel. Recently, there has been an increased interest in powering buildings with additional power sources such as solar, batteries, wind, gas generators, electric vehicles, and the like. Some power sources such as batteries, are bidirectional, which means they can act as an electrical load or as a source, this type of sources need to be managed to control and optimize their charge and discharge cycles. Other sources such as generators are unidirectional and therefore backfeeding needs to be prevented for this type of sources to prevent damage and other problems.

In systems with two power sources, a transfer switch can be used to selectively connect one of the two power sources to the building and to prevent electrical backfeed. While such transfer switches are an effective solution for a system with two power sources, transfer switches require the use of interlocking mechanisms which become very complicated systems for more than two power sources.

Furthermore, transfer switch-based electrical load management systems are not flexible in terms of facilitating different electric current levels at the inputs and outputs. Rather, the transfer switch is only configured to selectively connect one of the two power sources to the building.

In many photovoltaic installations (PV) the power generated by the PV modules is first transformed into AC current by means of microinverters or string inverters and fed back into the electrical panel through a branch breaker to be used by the loads. The amount of PV current is limited to 120% of the electrical panel bus rating, this is not optimal if higher utilization of renewable energy needs to be accomplished.

In buildings where electric vehicle (EV) chargers are installed, they typically represent one of the biggest loads that can be installed, their significant power requirements sometimes require a utility service upgrade and an electrical panel upgrade. These upgrades can be expensive to a point where it hinders the adoption of EV technology. Additionally, the batteries in EVs can store a significant amount of power that can be used to power all or certain loads in a building, this bidirectional flow of power for EVs is difficult to achieve with conventional distribution panels.

In buildings with multiple power sources, the amount of electrical equipment that is typically installed on a wall increases significantly, often requiring multiple disconnecting points and multiple metering points for each power source at different places in the wall, creating the need for emergency response personnel to locate the multiple disconnection points in the wall and turn them off one by one, this can pose significant delays or lead to increased risk when omitting disconnecting certain power sources. Additionally, there is a need to manage multiple power sources to optimize utilization of renewable energy and/or energy cost, this task would be extremely difficult to be performed manually by a homeowner.

In some buildings, addition of additional power sources or additional capacity is done gradually over time. If the system components are not carefully planned from the beginning it can lead to very costly upgrades or lead to overdesigned systems to accommodate future upgrades that might never happen.

In certain cases, homeowners have a need to ensure there is always power available such as for critically ill people in home care. In the event that electronic controls become nonoperational there is a need to circumvent the energy management system and directly connect the home to single power source to ensure that the energy management system will still provide energy to a house or building.

### SUMMARY

Embodiments include an electrical distribution panel having a central conductor is provided. The electrical distribution panel includes a plurality of input terminals that are each connected to a source, each of the plurality of input terminals include a circuit protection device, a sensing device, and an isolation device that connect the central conductor to a source, where one or more of the plurality of sources is bidirectional. The electrical distribution panel also includes a plurality of output terminals that are each connected to a load, each of the plurality of output terminals include a circuit protection device, a sensing device, and an isolation device that connect the central conductor to a load and a controller configured to receive data from the sensing device of each of the plurality of input and output terminals and to responsively control the isolation device of each of the plurality of input and output terminals.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 illustrates a block diagram of an electrical distribution panel in accordance with one or more embodiments of the present invention.

FIG. 2 illustrates a flowchart diagram of a method for performing load management by an electrical distribution panel in accordance with an embodiment of the present invention.

FIG. 3 illustrates a flowchart diagram of a method for performing load management by an electrical distribution panel in accordance with an embodiment of the present invention.

### DETAILED DESCRIPTION

As discussed above, interest in powering buildings with multiple power sources such as solar, batteries, wind, gas generators, electric vehicles and the like has increased recently. In addition, a power source management system should be able to facilitate different electric current levels at the inputs and outputs in addition to preventing electrical backfeed for unidirectional power sources and facilitating bidirectional power flow for bidirectional power sources. Such a system must also be able to facilitate the simultaneous disconnection of multiple power sources in case of emergency and work independently of the automatic control if it becomes not operational. In addition, such a system must be able to manage the power sources according to various optimization strategies.

In summary, a power source management system with the following characteristics is provided: management of multiple power sources, including bidirectional sources; simultaneous disconnection of all power sources: manual bypass of the electronic control system; anti-islanding feature to protect electrical crew workers; scalable, enabling gradual addition of power sources; configurable, facilitating different ratings for overcurrent protection devices; provide an alternative to avoid costly panel or utility service upgrades; load management, to maximize energy availability in case of power outages; and demand response, to prevent grid overload and capture potential savings.

Various technologies that pertain to configurable power source management devices for multiple electric power sources are presented. The disclosed configurable power source management devices are configured to selectively connect one or more of a plurality of sources of electrical power to one or more loads. In exemplary embodiments, the configurable power source management devices, also referred to herein as electrical distribution panels, include a plurality of input terminals that are each configured to selectively connect a different power source to a central conductor and a plurality of output terminals that are each configured to selectively connect different loads to the central conductor. The electrical distribution panel also includes a controller that is configured to selectively activate and deactivate the input and output terminals to optimize the utilization of the plurality of power sources and to prevent electrical backfeed between the different power sources. In exemplary embodiments, the electrical distribution panel includes an input disconnection switch that is accessible for the safety of all emergency personnel and is configured to disconnect all of the plurality of power sources from the central conductor.

The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

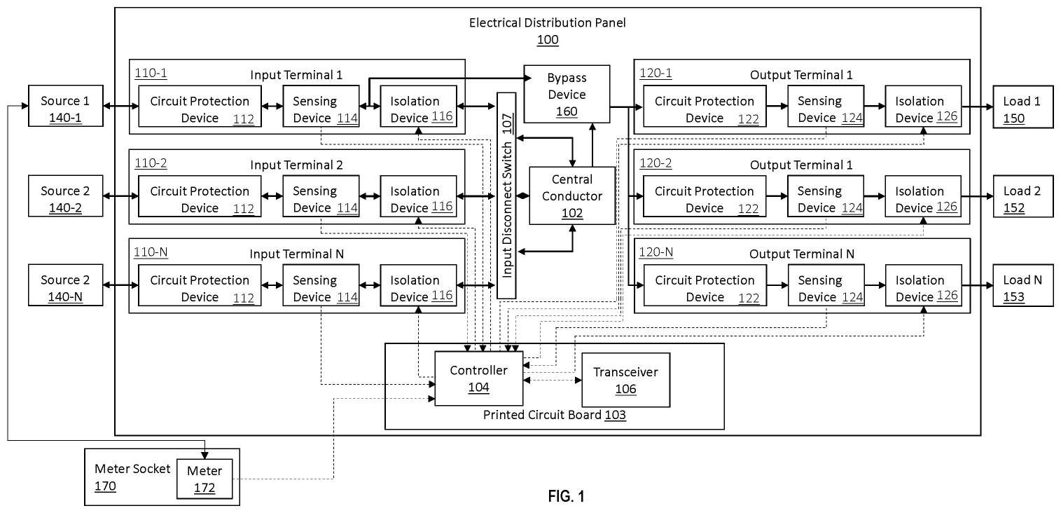

Referring now to FIG. 1, a block diagram of an electrical distribution panel 100 in accordance with one or more embodiments of the present invention is shown. As illustrated, electrical distribution panel 100 includes a central conductor 102, which may be a busbar, a copper wire, or the like. The central conductor 102 is connected to a plurality of input terminals 110-1, 110-2, and 110-N (referred to herein collectively as input terminals 110) via an input disconnect switch 107. Each of the plurality of input terminals 110 is connected to a different source 140 of electrical power. For example, input terminal 110-1 is connected to source 140-1, which may be an electrical grid operated by a utility provider. Utility source 140-1 may originate from an independent utility metering device 172 connecting into meter socket 170 located within the electrical distribution panel 100. Input terminal 110-2 is connected to source 140-2, which may be a natural gas-powered generator and input terminal 110-3 is connected to source 140-3, which may be a solar inverter. In exemplary embodiments, one or more of the sources 140 may be a bidirectional source, such as a battery back-up system that is configured to draw power from the electrical distribution panel 100 during charging and to provide power to the electrical distribution panel 100 when discharging. As will be appreciated by those of ordinary skill in the art, although three input terminals 110 are illustrated, the number of input terminals 110 is not limited to the embodiment shown.

In exemplary embodiments, the central conductor 102 is connected to a plurality of output terminals 120-1, 120-2, and 120-N (referred to herein collectively as output terminals 120) via a bypass device 160 In exemplary embodiments, the bypass device 160 is also connected to the first input terminal 110-1 and the central conductor 102. In one embodiment, the bypass device 160 is a manual transfer switch selectively configured to provide an alternate current path from one of the first input terminal 110-1 to one or more of the output terminals 120. In one embodiment, the bypass device 160 is connected to a combination of the plurality of output terminals 120 but not all of the output terminals 120.

In exemplary embodiments, the bypass device 160 is mechanically coupled with the input disconnection switch 107. In one embodiment, the mechanical coupling between the bypass device 160 and the input disconnection switch 107 is configured to prevent the bypass device 160 from being activated when the input disconnection switch 107 is disconnected.

In one embodiment, one or more of the output terminals 120 are connected to traditional electrical distribution panels, e.g., circuit breakers. In another embodiment, one or more of the plurality of output terminals 120 are directly connected to various loads. In exemplary embodiments, the first output terminal 120-1 is connected to a first load 150, which is a non-critical load, and the second output terminal 120-2 is connected to a second load 152, which is a critical load. In exemplary embodiments, the non-critical loads are loads that have been identified as being connected to systems/devices that do not need to be powered during times when the available electrical power is below a threshold level. Conversely, the critical loads are loads that have been identified as being connected to systems/devices that should be provided power during times when the available electrical power is below the threshold level. For example, in a residential building, lighting systems, cooking systems, and/or refrigeration devices may be considered to be critical loads while air conditioning systems and entertainment devices may be considered to be non-critical loads.

In exemplary embodiments, each of the input terminals 110 includes a circuit protection device 112, a sensing device 114, and an isolation device 116. The circuit protection device 112 is a circuit breaker that is configured to protect the electrical distribution panel 100 and the electrical cable coming from source 140 from damage caused by overcurrent or overload from or to (in case of bidirectional sources) the respective input source 140. The circuit protection device 112 may be a traditional (i.e., mechanical circuit breaker), a solid-state circuit breaker, a thermal circuit breaker, an electromagnetic circuit breaker, a fuse, a smart fuse, or the like. The sensing device 114 includes one or more of a current sensor and a voltage sensor that is configured to measure the magnitude and frequency of the current and voltage of the electrical power received from the respective input source 140. The sensing device 114 may be one of a current sensor and voltage sensor such as Rogowski coil, shunt resistor, current transformers, Hall effect sensor, electrostatic sensor, inductive sensor, and the like. In one embodiment, the isolation device 116 is a relay that is configured to selectively connect and disconnect the input terminal 110 to the central conductor 102. The isolation device 116 may generally be an electrically operated switching device such as a relay, solid-state relay, solid state switching, or an electro-mechanically actuated switch, or the like. Although the circuit protection device 112, the sensing device 114, and the isolation device 116 are illustrated as separate devices, in some embodiments the functions of these devices may be combined into a single physical device. For example, a solid-state circuit breaker device may be configured to perform the functions of the circuit protection device 112, the sensing device 114, and the isolation device 116.

In exemplary embodiments, each of the output terminals 120 includes a circuit protection device 122, a sensing device 124, and an isolation device 126. The circuit protection device 122 is a circuit breaker that is configured to protect respective loads 150, 152, 153 from damage caused by overcurrent or overload from the electrical distribution panel 100. The sensing device 124 includes one or more of a current sensor and a voltage sensor that is configured to measure the magnitude and frequency of the current and voltage of the electrical power provided to the respective loads 150, 152, 153. In one embodiment, the isolation device 126 is a relay that is configured to selectively connect and disconnect the output terminal 120 to the central conductor 102. Although the circuit protection device 122, the sensing device 124, and the isolation device 126 are illustrated as separate devices, in some embodiments the functions of these devices may be combined into a single physical device. For example, a solid-state circuit breaker device may be configured to perform the functions of the circuit protection device 122, the sensing device 124, and the isolation device 126.

In one embodiment, one or more of the circuit protection devices 112, 122, the isolation devices 116, 126, and the sensing devices 114, 124 of the input and output terminals 110, 120 are disposed in smart circuit breaker devices. As used herein, a smart circuit breaker device is an electronic device that can be controlled remotely. A smart circuit breaker device works in a similar way to a traditional circuit breaker by automatically cutting off the power supply when it detects an electrical overload or short circuit. Smart circuit breakers can be operated through a mobile application, a web portal, or integrated with other smart home systems. In another embodiment, one or more of the circuit protection devices 112, 122 of the input and output terminals 110, 120 are traditional circuit breaker devices. In exemplary embodiments, one or more of the circuit protection devices 112, 122 of the input and output terminals 110, 120 are configured to be replaceable. For example, circuit protection device 112 can be replaced without replacing the entire input terminal. In addition, one or more of the circuit protection devices 112, 122 of the input and output terminals 110, 120 are configured to be interchangeable with one another.

In one embodiment, one or more of the circuit protection devices 112, 122, the isolation devices 116, 126, and the sensing devices 114, 124 of the input and output terminals 110, 120 are disposed in smart fuse devices. As used herein, a smart fuse device is a protection mechanism that uses semiconductors instead of traditional melting fuses. In another embodiment, one or more of the circuit protection devices 112, 122 of the input and output terminals 110, 120 are a fuse.

In exemplary embodiments, the electrical distribution panel 100 includes printed circuit board 103 that includes multiple interconnected microprocessors, electrical circuits, and components thereon. The printed circuit board 103 includes a controller 104 that is configured to receive input signals from the sensing devices 114, 124 and to provide control signals to the isolation devices 116, 126. The printed circuit board 103 also includes a transceiver 106 that is configured to communicate with the controller 104.

In exemplary embodiments, the controller 104 is configured to monitor the characteristics of the power received from, and/or provided to, each of the sources 140 via the sensing devices 114 and to responsively control the isolation devices 116, 126. In one embodiment, the controller 104 is configured to identify that an available power from a source 140 connected to the one of the input terminals 110 has an abnormal condition. The presence of an abnormal condition may be determined based on the available power being outside a threshold voltage range or a frequency that is outside a threshold frequency range. Based on determining that the available power from a source 140 connected to one of the input terminals 110 has an abnormal condition, the controller 104 is configured to disconnect that source 140 from the central conductor 102 via the corresponding isolation device 116.

In another embodiment, the controller 104 is configured to determine the total amount of available power from the plurality of sources 140 and to responsively control isolation devices 126. For example, the controller 104 is configured to selectively disconnect the non-critical load 152 from the central conductor 102 via the isolation device 126 based on a determination that the total available power from the plurality of sources 140 is below a threshold value.

In exemplary embodiments, the controller 104 is configured to receive signals from meter 172. These signals include but are not limited to pricing information and demand response signals. The controller 104 will use this information among other inputs such as but not limited to user preferences, measured variables (e.g., values measured by the sensing devices 114, 124), actual and forecasted weather conditions and energy prices to determine the status of the system. The status of the system can include but is not limited to charge or discharge operations, available inputs, and measured loads.

In exemplary embodiments, the transceiver 106 is configured to communicate with one or more external systems via wired or wireless communication. In one embodiment, one of the external systems is a user device, such as a smartphone, of an owner/operator of the electrical distribution panel 100. In one embodiment, a user device may be configured to communicate with the controller 104 of the electrical distribution panel 100 via the transceiver 106 to manually control the isolation devices 116, 126 and/or to create or modify control algorithms utilized by the controller 104. In another embodiment, one of the external systems is a control system associated with a source 140. For example, one of the sources 140 may be a natural gas generator and the transceiver 106 may provide communication between the controller 104 and the control system of the natural gas generator such that the controller 104 can monitor and/or control the operational status of the natural gas generator. In another example, one of the sources 140 may be a battery back-up system and the transceiver 106 may provide communication between the controller 104 and the control system of the battery back-up system such that the controller 104 can monitor and/or control the operational status of the battery back-up system.

In one embodiment, one of the of the sources 140 may be a utility provider, e.g., a company that operates an electrical distribution grid, and the transceiver 106 may provide communication between the controller 104 and the utility provider so that the controller may receive an operational status and rate information from the utility provider. In exemplary embodiments, the controller 104 may be configured to selectively activate auxiliary power sources, such as a natural gas generator or a battery back-up system based on a determination or notification of a service disruption of the utility provider. In addition, the controller 104 may be configured to selectively activate auxiliary power sources, such as a natural gas generator or a battery back-up system based on a notification that the rate being charged by the utility provider is greater than a threshold rate.

In exemplary embodiments, the controller 104 of the printed circuit board 103 is configured to receive input signals from the sensing device 124 and to responsively control the operation of the isolation device 126. In addition, the transceiver 106 may be configured to communicate with a source 140 or a load 150 to obtain a state-of-charge, an operational mode, or other information from the source 140 or the load 150. The transceiver 106 may also transmit operational commands received from the controller 104 to the source 140 or the load 150.

In exemplary embodiments, the electrical distribution panel 100 is configured to connect multiple power sources into a single device, thereby eliminating multiple separate installations typically required for a similar function (junction boxes, transfer switches, isolation switches, etc. . . . ). As described above, all of the sources 140 can be disconnected by an input disconnection switch 107 that is configured to be accessible to emergency personnel. Additionally, all power sources and loads are protected from any overcurrent and short-circuit events, preventing damage to user-installed equipment, busbars connected to all loads, and users. Furthermore, the electrical distribution panel 100 includes a user-programmable controller 104 that is configured to allow the user to optimize the use of different power sources based on user preference, weather patterns, utility rates, and the like.

In exemplary embodiments, the controller 104 is configured to selectively disconnect, either sequentially or simultaneously, one or more of the sources 140 and the loads 150 from the central conductor 102 via the isolation devices 116, 126 of their respective terminals 110, 120. In one embodiment, where the disconnection is sequentially performed, the controller 104 is configured to determine the sequence of disconnection based on, but not limited to, user preferences, measured variables (e.g., values measured by the sensing devices 114, 124), actual and forecasted weather conditions, and energy prices.

In exemplary embodiments, the electrical distribution panel 100 includes one or more meter sockets 170 that are configured to accommodate utility meters 172. The utility meters 172 are configured to track the energy obtained from a source 140 or provided to a load 150. For example, a utility meter 172 may be configured to track an amount of power received from a source 140-1, such as an electrical grid.

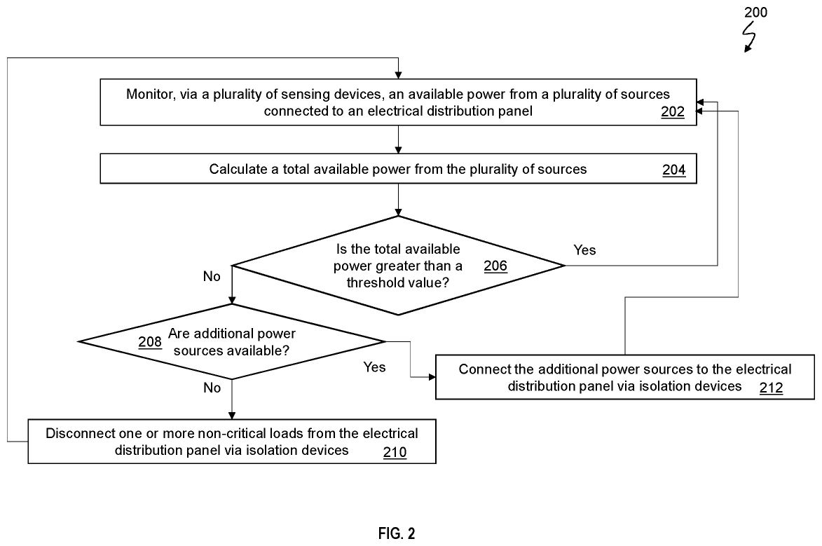

Referring now to FIG. 2, a flowchart diagram of a method 200 for performing load management by an electrical distribution panel in accordance with an embodiment of the present invention. In exemplary embodiments, the method 200 is performed by a controller 104 of an electrical distribution panel 100, as shown in FIG. 1. As shown at block 202, the method 200 includes monitoring, via a plurality of sensing devices, an available power from a plurality of sources connected to the electrical distribution panel. Next, as shown at block 204, the method 200 includes calculating the total available power from the plurality of sources. The method 200 also includes determining whether the total available power is greater than a threshold value, as shown at decision block 206.

Based on a determination that the total available power is greater than the threshold value, the method 200 returns to block 202 and continues to monitor the available power from the plurality of sources connected to the electrical distribution panel. Based on a determination that the total available power is not greater than the threshold value, the method 200 proceeds to decision block 208 and determines whether any additional power sources are available. In one example, the electrical distribution panel may be connected to a natural gas generator or a battery back up system that is not currently providing power to the electrical distribution panel. Based on a determination that no additional power sources are available, the method 200 proceeds to block 310, and one or more non-critical loads are disconnected from the electrical distribution panel via one or more isolation devices. Based on a determination that an additional power source is available, the method 200 proceeds to block 212 and connects the additional power sources to the electrical distribution panel via an isolation device.

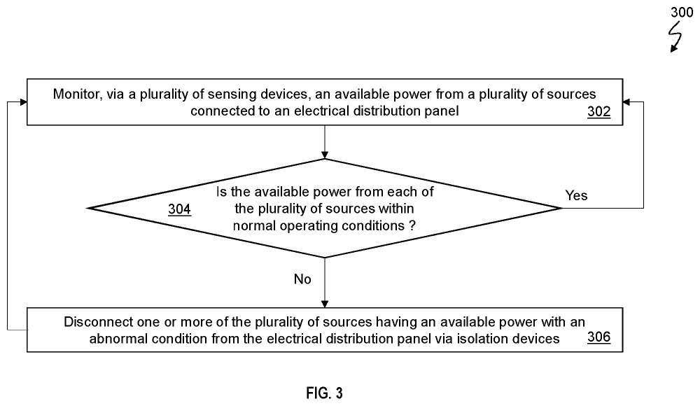

Referring now to FIG. 3, a flowchart diagram illustrating a method 300 for performing load management by an electrical distribution panel in accordance with an embodiment of the present invention is shown. In exemplary embodiments, the method 300 is performed by a controller 104 of an electrical distribution panel 100, as shown in FIG. 1. As shown at decision block 302, the method 300 includes monitoring, via a plurality of sensing devices, available power from a plurality of sources connected to an electrical distribution panel. Next, as shown at decision block 304, the method 300 includes determining whether the available power from each of the plurality of sources is within normal operating conditions. In exemplary embodiments, each of the plurality of sources is associated with a set of normal operating conditions that include one or more of a current/voltage frequency range and a current/voltage magnitude. As shown at block 306, the method 300 includes disconnecting one or more of the plurality of sources having available power with an abnormal condition from the electrical distribution panel via isolation devices, wherein an abnormal condition is determined based on the available power being outside of the set of normal operating conditions.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. An electrical distribution panel comprising:
a central conductor;
a plurality of input terminals that are each configured to be connected to one of a plurality of sources, wherein each of the plurality of input terminals include a circuit protection device, a sensing device, and an isolation device that connect the central conductor to one of the plurality of sources and wherein one or more of the plurality of sources is bidirectional;
a plurality of output terminals that are each configured to be connected to one of a plurality of loads, wherein each of the plurality of output terminals include a circuit protection device, a sensing device, and an isolation device that connect the central conductor to one of the plurality of loads; and
a controller configured to receive data from the sensing device of each of the plurality of input and output terminals and to responsively control the isolation device of each of the plurality of input and output terminals.

2. The electrical distribution panel of claim 1, wherein the controller is configured to selectively disconnect the loads from the central conductor via the isolation device of their respective output terminal based on a determination that an available power from the plurality of sources is below a threshold value.

3. The electrical distribution panel of claim 1, wherein the controller is configured to sequentially or simultaneously disconnect the loads from the central conductor via the isolation device of their respective output terminal, where a sequence of disconnection is determined by the controller based on but not limited to user preferences, measured variables, actual and forecasted weather conditions, and energy prices.

4. The electrical distribution panel of claim 1, further comprising an input disconnect switch configured to selectively disconnect each of the plurality of input terminals from the central conductor.

5. The electrical distribution panel of claim 1, wherein one or more of the circuit protection devices is a circuit breaker.

6. The electrical distribution panel of claim 1, wherein one or more of the isolation devices is an electrically actuated switching device that is controlled by the controller.

7. The electrical distribution panel of claim 1, wherein the controller is configured to selectively disconnect one of the plurality of input terminals from the central conductor via the isolation device of the one of the plurality of input terminals based on a determination that an available power from the source of the plurality of sources connected to the one of the plurality of input terminals has an abnormal condition.

8. The electrical distribution panel of claim 7, wherein the abnormal condition determined based on the available power being outside a threshold voltage range or a frequency that is outside a threshold frequency range.

9. The electrical distribution panel of claim 1, wherein the controller is further configured to control the isolation device of each of the plurality of input and output terminals based on commands received from a transceiver.

10. The electrical distribution panel of claim 1, further comprising a transceiver configured to communicate with the controller.

11. The electrical distribution panel of claim 1, wherein one or more of the circuit protection device, the isolation device, and the sensing device of each input and output terminals are disposed in a solid-state circuit breaker device.

12. The electrical distribution panel of claim 1, wherein one or more of the circuit protection device, the isolation device, and the sensing device of each input and output terminals are disposed in a smart circuit breaker device.

13. The electrical distribution panel of claim 1, wherein one or more of the circuit protection device, the isolation device, and the sensing device of each input and output terminals are disposed in a smart fuse device.

14. The electrical distribution panel of claim 1, further comprising a manual transfer switch selectively configured to provide an alternate current path from one of the input terminals to any combination of the plurality of output terminals.

15. The electrical distribution panel of claim 14, further comprising an input disconnect switch configured to selectively disconnect each of the plurality of input terminals from the central conductor and wherein the manual transfer switch is coupled to the input disconnect switch to prevent activation of the manual transfer switch when the input disconnect switch is disconnected.

16. The electrical distribution panel of claim 1, where one or more of the circuit protection devices of the plurality of input terminals and the plurality of output terminals are replaceable.

17. The electrical distribution panel of claim 1, wherein one or more of the circuit protection devices is a fuse.

18. The electrical distribution panel of claim 1, further comprising one or more meter sockets to accommodate each a utility meter.
